(19) United States
(12) Patent Application Publication
(10) Pub. No.: US 2008/0216614 A1
(43) Pub. Date: Sep. 11, 2008

(54) DOUBLE ACTING SPANNER WRENCH

(75) Inventor: Robert D. Fordice, Shoreline, WA (US)

Correspondence Address: INTELLECTUAL PROPERTY MANAGEMENT;BOEING MANAGEMENT COMPANY, P.O. BOX 2515, MAIL CODE 110-SD54, SEAL BEACH, CA, 90740-1515, US

(73) Assignee: THE BOEING COMPANY, Chicago, IL (US)

(21) Appl. No.: 12/044,661

(22) Filed: Mar. 7, 2008

Related U.S. Application Data
(60) Provisional application No. 60/905,675, filed on Mar. 7, 2007.

(51) Int. Cl. B25B 13/10

(52) U.S. Cl. 81/176.3

(57) ABSTRACT

A wrench with the property of applying two opposing forces to a pair of spiral washers. The basic design for the wrench can be used to tighten or loosen the pair of spiral washers in a controlled, repeatable manner.

### CROSS REFERENCE TO RELATED APPLICATIONS

This application claims priority to U.S. Provisional Application Ser. No. 60/905,675 filed on 7 Mar. 2007 by Robert D. Fordice entitled “Helical Preload Washer Double Acting Spanner Wrench,” the contents of which are incorporated herein by reference.

### TECHNICAL FIELD

The embodiments described herein generally relate to tools and more specifically relates to tools that provide tightening or loosening forces to a pair of lock nuts or lock washers.

### BACKGROUND

Helical or spiral washers are commonly used in pairs to preload threaded fittings on hydraulic actuators. Each washer has a flat surface, a helical surface, and notches along the outer circumference. The helical faces of the washers allow a preload force to be imparted on the threaded components with which they are assembled. Typically, two washers are installed with their helical faces opposing each other. As the washers are rotated in opposite directions against each other, the outer flat surfaces generate a preload force that prevents backlash during through-zero cyclic loading. This preload must be greater than the load generated by the actuator during test cycles to prevent backlash in the load linkage.

Tightening and loosening spiral washers can be labor intensive and time consuming on tests that use many hydraulic actuators. Specially designed spanner wrenches, one per spiral washer, are typically recommended for tightening or loosening the washers. Often the task has been accomplished using impact devices on the spanner wrenches, often resulting in damage to the washer and or the wrench. Such methods do not allow regulation of the amount of preload force applied to the threaded fasteners by the washers.

Although other techniques exist, all prove ineffective on the shop floor due to the magnitude of the forces required, the lack of a method to apply forces simultaneously to each washer, and the lack of a good way to hold one washer “still” while applying wrench forces on the other.

### SUMMARY

In accordance with the disclosure, the problem of applying controllable, measurable forces to a pair of spiral washers is solved by an apparatus which imparts equal but opposite circumferential forces on two washers simultaneously. The circumferential forces are a function of a single input force or pressure controlled by an operator.

One embodiment of such an apparatus is a double-acting spanner wrench. The wrench engages the washers via hooking onto slots in the washers, and effectively pulls each washer in opposite circumferential directions with respect to the other. The hooks pull towards each other as the lever ends of the wrench are drawn together by a threaded draw bolt as it is rotated by an operator with a socket or ratchet wrench. The pivot mechanism for the wrench is such that the gripping ends move with the washers and also allows the wrench to accommodate a number of different washer sizes.

The task of preloading threaded rod and cylinder ends can now be accomplished with one tool. The load factor can be precisely controlled with simple dial marks on the washers for visual reference; alternatively washer force can be controlled by using a torque wrench on the draw bolt. The fatigue factor and risk to technicians is greatly reduced by using the present invention over alternative means.

One of the advantages of the wrench is that it is easy to use and can simultaneously tighten or loosen two lock washers with respect to each other. Another advantage is that the wrench can be used to apply a measurable and repeatable torque to two spiral washers which, in turn, results a measurable and repeatable preload force.

Various embodiments of the wrench can be used to tighten or loosen helical lock washers, lock nuts, jam nuts, and collars which would otherwise require the use of two wrenches.

### BRIEF DESCRIPTION OF THE DRAWINGS

FIG. 1 is a perspective view of a spanner wrench according to a number of embodiments.

FIG. 2 is a top view of a spanner wrench according to other embodiments.

FIG. 3 is a side view of the wrench of FIG. 2.

FIG. 4 illustrates the wrench in operation.

### DETAILED DESCRIPTION OF THE INVENTION

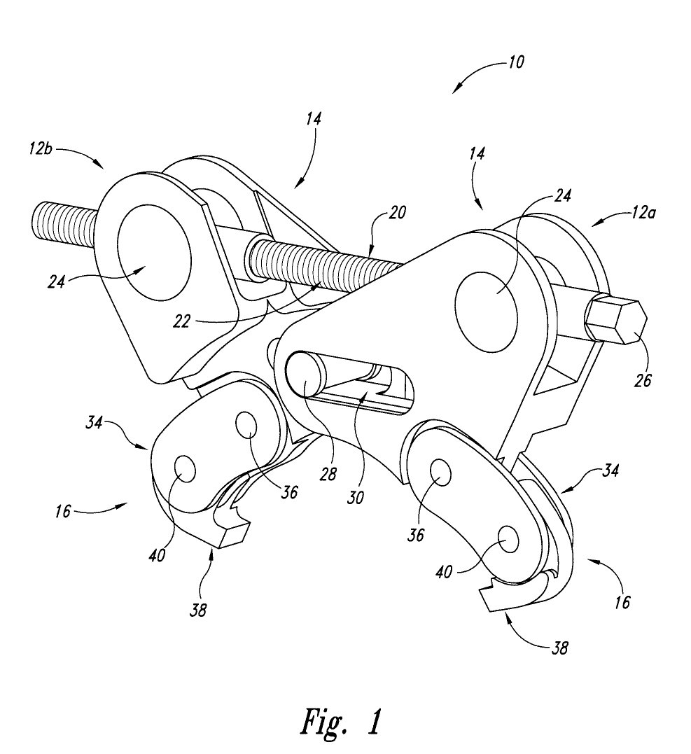

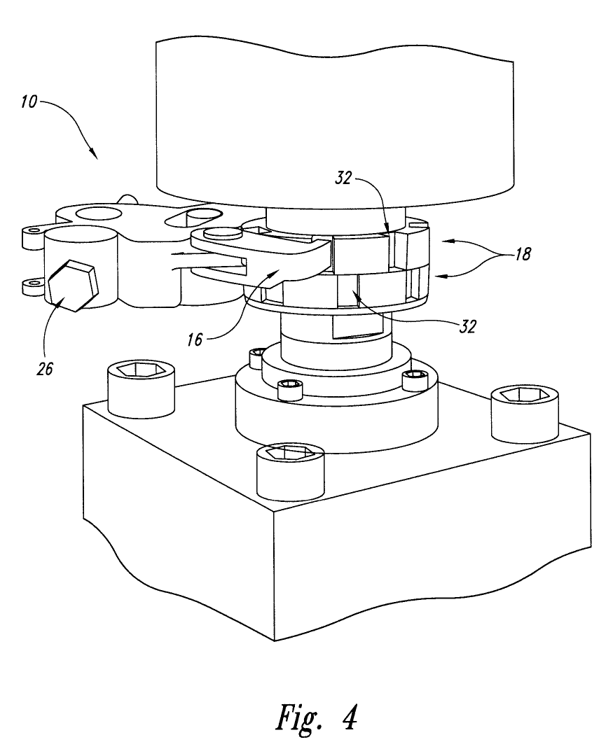

As shown in FIGS. 1, 2, and 3, a spanner wrench 10 for spiral washers is configured to impart opposite rotational forces to the washers, with the opposite rotational forces being a function of a single applied force. According to a number of embodiments, the wrench 10 may include a pair of coupling devices 12a and 12b each including a lever end 14 and a gripping end 16. The gripping ends 16 are adapted to engage a respective one of the washers 18, such as shown in FIG. 4.

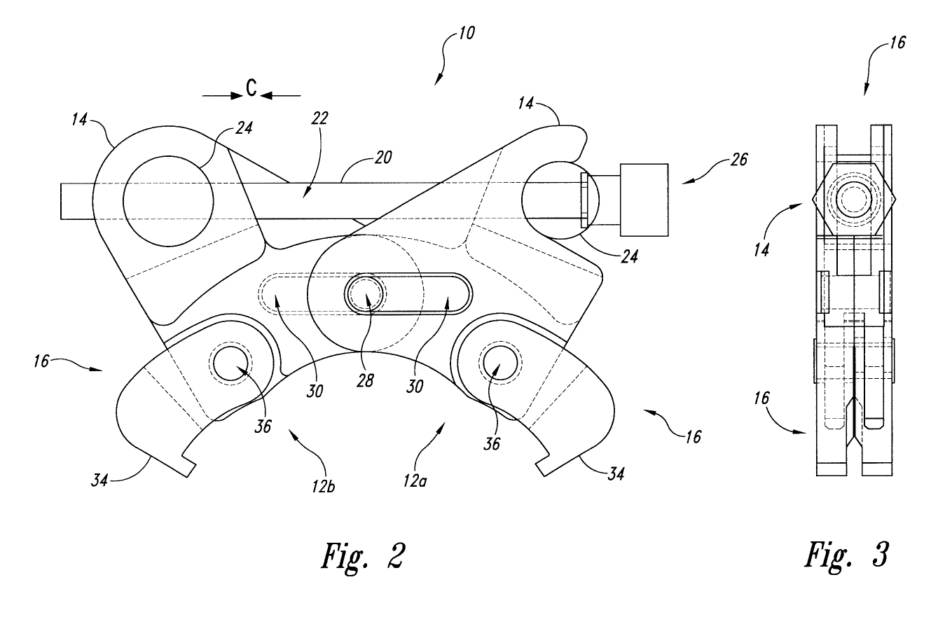

As shown in FIG. 2, the coupling devices 12 are assembled such that when the gripping ends 16 engage washers 18, a squeezing force applied to the lever ends 14 as indicated by arrows C cause the washers 18 to rotate in opposite angular directions (e.g., clockwise and counterclockwise, respectively), thus applying a preload force.

In some of the embodiments, the squeezing force applied to the lever end 14 may be applied by a lever device 20 which is operatively attached to the lever ends 14 of each of the coupling devices 12. For example, the lever device 20 may include a threaded shaft 22 operatively engaged with threaded seats 24 pivotally disposed on the lever ends 14. The shaft 22 may have a nut 26 disposed on one end thereof for engaging with a complementary tool.

Accordingly, when the threaded shaft 22 is rotated clockwise, the lever ends 14 are drawn inwardly or toward each other, thereby tightening the wrench's grip on the washers 18 and rotating the washers 18 respectively engaged therewith in opposite rotational directions. And when the threaded shaft 22 is rotated counterclockwise, the lever ends 14 are urged outwardly or away from each other, thereby loosening the wrench's grip on the washers.

As shown in FIG. 1, the coupling devices 12 are operatively and pivotally attached to each other by, for example, an axle 28 disposed in respective slots 30 formed in the devices 12. Accordingly, when the shaft 22 is actuated, the lever ends 14 and the gripping ends 16 rotate about the axle 28, while the slots 30 allow translation of the axle 28 therein. In many embodiments, the coupling devices 12 may be configured such that approximately 45 degrees of rotation about the axle 28 is enabled.

With reference to FIG. 4, in many applications, each of the washers 18 may include one or more annular notch 32. In such embodiments, the gripping end 16 of each of the coupling devices 12 may include a latch 34 configured to engage with the notches 32 of a respective one of the washers 18.

As shown in the embodiments of FIGS. 1 and 2, the latches 34 may be pivotally attached by respective axles 36. In addition, the latches may include a distal toe plate 38 configured to engage with the notches 32. As shown in the embodiment of FIG. 1, the toe plates 38 may be pivotally attached by respective axles 40.

While embodiments have been presented in the foregoing detailed description, it should be appreciated that a number of variations exist and applications exist. It should also be appreciated that the described embodiments are only examples and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method of rotating a pair of spiral washers in opposite directions, the method comprising:
engaging the washers with a device such that when a single force in a single direction is applied to the device, the washers rotate in opposite directions; and
applying a force to the device.

2. Apparatus for tightening or loosening a pair of spiral washers by imparting opposite rotational forces to the washers, said opposite rotational forces being a function of a single applied force.

3. The apparatus of claim 2 further comprising:
a pair of coupling devices each including:
a lever end; and
a gripping end adapted to engage a respective one of the washers;
the coupling devices being assembled such that when the gripping ends engage the washers, a squeezing force applied to the lever ends cause the washers to rotate in opposite angular directions, thus applying a preload force.

4. The apparatus of claim 3 wherein the squeezing force applied to the lever end is applied by a lever device which is operatively attached to the lever ends of each of the coupling devices.

5. The apparatus of claim 4 wherein the lever device includes a threaded shaft such that when the threaded shaft is rotated, the lever ends move in opposite directions with respect to each other.

6. The apparatus of claim 3 wherein each of the washers includes at least one annular notch;
the gripping end of each of the coupling devices including a pair of pivotal latches configured to engage with the notches of a respective one of the washers.

7. A method of rotating a pair of spiral washers, the method comprising:
providing a pair of operatively hinged coupling devices each having a gripping end and a lever end;
engaging the washings with the gripping ends; and
applying a compressive force to the lever ends to urge the lever ends toward each other such that the gripping ends rotate the washers in opposite directions.

8. The method of claim 7 wherein the compressive force to the lever ends is provided by an operator-controlled torque to a draw bolt assembly.
